(19) United States
(12) Patent Application Publication
(10) Pub. No.: US 2026/0156216 A1
(43) Pub. Date: Jun. 4, 2026

(54) IMAGE PROCESSING APPARATUS, IMAGE PROCESSING METHOD, COMPUTER-READABLE STORAGE MEDIUM, AND IMAGE FORMATION SYSTEM

(71) Applicant: CANON KABUSHIKI KAISHA, Tokyo (JP)

(72) Inventor: MOMOKA FUJIMOTO, Kanagawa (JP)

(21) Appl. No.: 19/401,814

(22) Filed: Nov. 26, 2025

(30) Foreign Application Priority Data
Dec. 3, 2024 (JP) 2024-210525

(51) Int. Cl. H04N 1/00; B41J 2/21; B41J 3/44; B41J 11/00; G06V 10/28; G06V 10/764; H04N 1/40; H04N 1/60

(52) U.S. Cl. CPC H04N 1/00045; B41J 2/2117; B41J 2/2135; B41J 2/2139; B41J 2/2142; B41J 3/44; B41J 11/0015; G06V 10/28; G06V 10/764; H04N 1/00037; H04N 1/00082; H04N 1/40012; H04N 1/6027

(57) ABSTRACT

An image processing apparatus obtains image data acquired by scanning of an image formed on a printing medium using a printing element configured to eject an ink. Based on a histogram representing a distribution of pixel values in a specified region on the image, the image processing apparatus classifies pixel values of the image into a mark distribution and into a foundation distribution. The mark distribution includes pixel values of a portion of corresponding to a detection mark of the image being printed with the ink. The foundation distribution includes pixel values of a portion of the image being not printed with the ink by no ejection. The image processing apparatus generates characteristic data based on the mark distribution. The characteristic data represents a density characteristic of the ink ejected from the printing element.

### BACKGROUND

### Field of the Technology

The present disclosure relates to a technique for improving image quality.

### Description of the Related Art

As conventionally known, images printed by inkjet printing apparatuses may have density unevenness due to, for example, quality variability caused during the manufacturing process, deterioration over time, or the like. To improve density unevenness on an image, for example, Japanese Patent Laid-Open No. 2001-310535 (hereinafter referred to as Literature 1) discloses a method called head shading. The method described in Literature 1 attempts to achieve image density uniformity by correcting density unevenness based on results of scanning a density test pattern.

### SUMMARY

An image processing apparatus according to an aspect of the present disclosure has an obtainment unit configured to obtain image data acquired by scanning of an image formed on a printing medium using a printing element configured to eject an ink, a classification unit configured to classify, based on a histogram representing a distribution of pixel values in a specified region on the image, pixel values of the image into a mark distribution and into a foundation distribution, the mark distribution including pixel values of a portion of corresponding to a detection mark of the image being printed with the ink, the foundation distribution including pixel values of a portion of the image being not printed with the ink by no ejection, and a generation unit configured to generate characteristic data based on the mark distribution, the characteristic data representing a density characteristic of the ink ejected from the printing element.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of a configuration of an image formation system according to the present embodiment;

FIG. 2 is a functional block diagram showing an example of a control configuration of an image formation apparatus in FIG. 1;

FIG. 3 is a conceptual diagram of a use case of regular printing;

FIG. 4A is a diagram showing an example of a single-color detection pattern;

FIG. 4B is a diagram showing an example of a white-ink detection pattern;

FIG. 5A is a diagram showing detection patterns for four color inks;

FIG. 5B is a diagram showing detection patterns for four color inks and a white ink;

FIG. 5C is a diagram showing a detection pattern for a white ink;

FIG. 6A is a diagram showing an example of a paper being conveyed in a conveyance direction before a detection pattern is printed on the paper;

FIG. 6B is a diagram showing an example of a single-color detection pattern after being printed on the paper and before being scanned by a scanner unit;

FIG. 6C is a diagram showing an example of a state where the single-color detection pattern is being scanned by the scanner unit and the white-ink detection pattern is being printed on the paper;

FIG. 6D is a diagram showing an example of a state where the white-ink detection pattern is being scanned by the scanner unit;

FIG. 7 is a flowchart illustrating processing in FIGS. 6A, 6B, 6C, and 6D;

FIG. 8 is a flowchart illustrating details of the process in S707 in FIG. 7;

FIG. 9A is a diagram showing an example of being set as a specified region on the image surrounded by the black thick line on the range of the distribution of pixel values of the image by the process in S804 in FIG. 8;

FIG. 9B is a diagram showing an example of a histogram of the image representing the distribution of pixel values in the specified region on the image surrounded by the black thick line in FIG. 9A;

FIG. 10 is a diagram showing an example of being calculated as a degree of separation of two groups based on the distribution of pixel values;

FIG. 11 is a diagram showing an example of the detection pattern used in the process in S806 in FIG. 8;

FIG. 12 is a diagram showing an example of the detection pattern obtained by execution of the process in S807 in FIG. 8; and

FIG. 13 is a diagram showing a correction table representing density characteristic of the ink.

### DESCRIPTION OF THE EMBODIMENTS

Preferred embodiments of the present invention are described in detail below with reference to the drawings attached hereto. Note that the following embodiments are not to limit the matters disclosed herein, and also, not all the combinations of features described in the following embodiments are necessarily essential as solutions provided by the present disclosure. Note that the same constituents are denoted by the same reference numeral.

### (Overview)

An inkjet printing apparatus is provided with a printhead. There may be an attachment error in the position where printhead is attached. There may also be an attachment error in the relative attachment positions between a plurality of printheads. These attachment errors may result in the factor that brings the shift of ink landing at the time of ink landing on a printing medium. Thus, error in the attachment of the printhead may lead to lower print quality. There are other errors that may occur during the manufacturing process other than the printhead attachment errors. For example, ejection characteristics may also vary, such as the amount of ink ejected from each of a plurality of nozzles. Variability in ejection characteristics of each of a plurality of nozzles may also be caused due to the printhead deteriorating over time. The variability in ejection characteristics of each of a plurality of nozzles brings density unevenness. Therefore, the variability in ejection characteristics of each of a plurality of nozzles may cause the factor of lower print quality.

Correction using a test pattern is know as a technique for correcting the density unevenness based on the detection result of detecting degradation in print quality. Literature 1 discloses the following technique. In other words, a test pattern printed in a plurality of densities is scanned, and according to the scan results, a group of correction tables is selected based on the density unevenness occurring in each density domain. Such operation resolves different density unevenness occurring depending on the density domain, such as a low density domain, an intermediate density domain, or a high density domain.

However, in a case where, for example, a test pattern corresponding to a low density region is being stored and is printed and scanned according to the technique described in Literature 1, the test pattern may be difficult to detect in the following case. Specifically, in a case where the test pattern is printed with white or the test pattern is printed by ejection of a primer (also referred to as a reaction liquid), there is small contrast between the color of the printing medium and the color of the test pattern. Then, it may be difficult to scan the density test pattern. That it is difficult to scan a density test pattern may mean that it is difficult to generate characteristic data representing the ink's density characteristic based on the density test pattern.

Thus, in the present disclosure, an image formed on a printing medium by ink ejection is scanned to obtain image data. Based on a histogram of the image representing the distribution of pixel values in a specified region on the image among pixel values forming the image data, the pixel values are classified into a mark distribution and into a foundation distribution. The mark distribution includes pixel values of the detection mark printed with ink. The foundation distribution includes pixel values corresponding to the printing medium. Based on the mark distribution, characteristic data representing the density characteristic of the ink is generated. In this series of operations, classification into the mark distribution and into the foundation distribution is done using a histogram of the image. Because the histogram of the image maps the number of times each pixel value appears, the mark distribution and the foundation distribution can be classified even in a case where there is small color contrast between the density test pattern and the printing medium. This enables characteristic data representing the ink's density characteristic to be generated based on the mark distribution separated from the foundation distribution. Then based on this characteristic data, density correction can be made. Hence, the density test pattern can be detected even under difficult conditions for scanning the density test pattern, and density unevenness can therefore be corrected.

### (Overall Configuration)

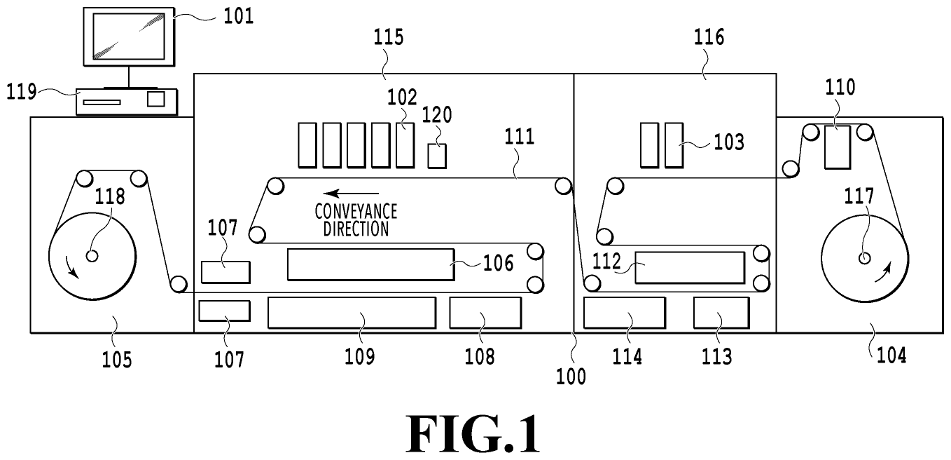

FIG. 1 is a diagram showing an example configuration of an image formation system according to the present embodiment. The image formation system includes an image formation apparatus 100, a terminal device 119, and a UI operation panel 101. The image formation apparatus 100 is an apparatus that forms an image on a continuous sheet of paper 111 (hereinafter also referred to as paper 111). The paper 111 used in the present embodiment is an elongated printing medium on which images can be formed continuously. Thus, the paper 111 is an elongated sheet that supports continuous printing. Note that the paper 111 may be a continuous business form. In the present embodiment, the image formation apparatus 100 includes a paper feed unit 104, a first print unit 116, a second print unit 115, and a wind-up unit 105.

### (Paper Feed Unit 104)

The paper feed unit 104 is disposed at the side of a stage before the image formation apparatus 100. The paper feed unit 104 includes a skew correction unit 110. The skew correction unit 110 includes, for example, a plurality of rollers. In a case where the paper 111 is conveyed obliquely to the skew correction unit 110, the skew correction unit 110 adjusts the orientation of the paper 111 being conveyed obliquely to the orientation in the conveyance direction by appropriately adjusting the rotation amounts of the plurality of rollers. The paper feed unit 104 is a unit that supplies the paper 111 to the first print unit 116. The paper feed unit 104 can house the paper 111. The paper 111 is housed in the paper feed unit 104 in a state wounded on a paper core. The paper feed unit 104 rotates the paper core of the paper 111 about a rotation axis 117. As a result of this operation, the paper 111 is conveyed to the image formation apparatus 100 at a certain speed through a plurality of rollers such as a conveyance roller and a paper feed roller.

### (First Print Unit 116)

The first print unit 116 includes a first printhead 103, a dryer unit 112, a cooler unit 113, and a cooler unit 114. The first printhead 103, the dryer unit 112, the cooler unit 113, and the cooler unit 114 are disposed in this order from an upstream side to a downstream side in the direction in which the paper 111 is conveyed. The first printhead 103 is a unit that performs printing using a spot color other than print basic colors (CMYK). In the spot color printing, a printing material other than the print basic colors, such as, for example, a white ink or a rection liquid, is printed on the paper 111. The dryer unit 112 heats and dries the ink ejected from the first printhead 103 onto the paper 111. The cooler units 113, 114 cool the ink ejected to the paper 111 and then heated. Also, the first print unit 116 is provided with a plurality of conveyance rollers. The conveyance rollers of the first print unit 116 convey the paper 111 from the paper feed unit 104 to the second print unit 115 in the conveyance direction.

### (Second Print Unit 115)

The second print unit 115 includes a mark detection sensor 120, a second printhead 102, a drier unit 106, a cooler unit 108, a cooler unit 109, and a scanner unit 107. The mark detection sensor 120, the second printhead 102, the drier unit 106, the cooler unit 108, the cooler unit 109, and the scanner unit 107 are disposed in this order from the upstream side to the downstream side in the direction in which the paper 111 is conveyed. The second printhead 102 is a unit that performs printing using a basic print color (CMYK). Also, the second print unit 115 is provided with a plurality of conveyance rollers. The conveyance rollers of the second print unit 115 convey the paper 111 from the first print unit 116 to the wind-up unit 105 in the conveyance direction.

### (Wind-Up Unit 105)

The wind-up unit 105 is disposed at the side of a stage after the image formation apparatus 100. The wind-up unit 105 is a unit that winds up the paper 111 conveyed from the image formation apparatus 100 into a roll about a rotation axis 118 of a paper core. As shown in FIG. 1, for example, the wind-up unit 105 can keep the paper 111 in a rolled state by winding the paper 111 on the paper core. The wind-up unit 105 rotates the paper core of the paper 111 about the rotation axis 118 of the paper core. As a result of this operation, the paper 111 is wound up about the rotation axis 118 at a certain speed through a plurality of rollers such as a conveyance roller and a paper feed roller, as a final product of the paper 111.

### (Preparation for Printing)

Before printing starts, as preparation for the printing, for example, a worker threads the paper 111 from the paper feed unit 104 to the wind-up unit 105. Specifically, first, the paper 111 is set in the paper feed unit 104, and the leading edge of the paper 111 is threaded above the skew correction unit 110. Next, the paper 111 is threaded below the first printhead 103 of the first print unit 116. Next, the paper 111 is threaded below the dryer unit 112 and above the cooler unit 113 and the cooler unit 114. Next, the paper 111 is threaded below the mark detection sensor 120 and the second printhead 102 of the second print unit 115 and is threaded below the drier unit 106 and above the cooler unit 108 and the cooler unit 109. In the present embodiment, the scanner unit 107 is assumed as a unit used for positioning during image formation. After being threaded through the scanner unit 107, the paper 111 is wound onto the wind-up unit 105. After the paper 111 is thus threaded inside the image formation apparatus 100, a print job is submitted to the terminal device 119. After the submission of the print job, printing starts upon pressing of a Start Print button displayed on the UI operation panel 101. A printed image is scanned by the scanner unit 107. The image scanned by the scanner unit 107 is analyzed by the terminal device 119 and inspected whether there is any problem on a printed product.

### (Control Configuration)

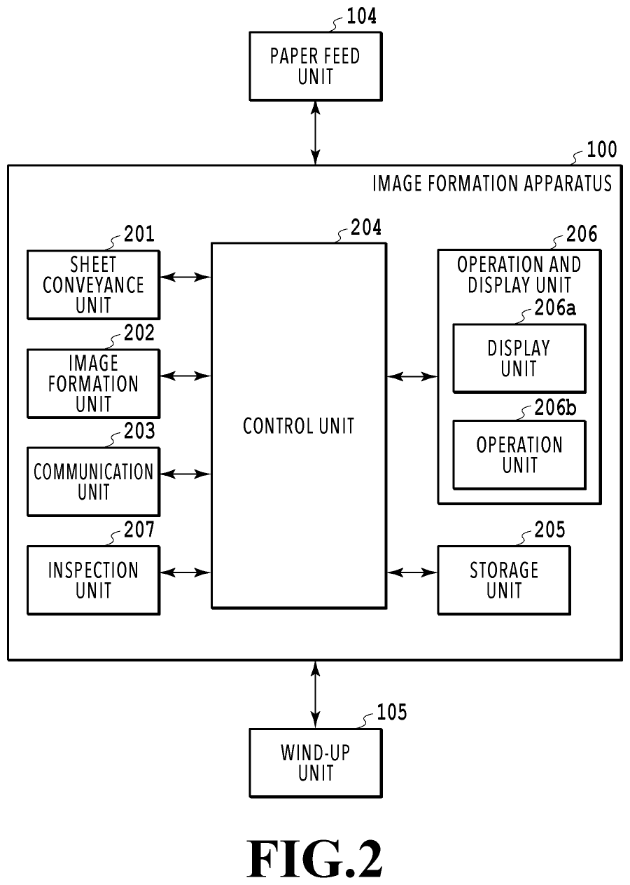

FIG. 2 is a functional block diagram showing an example control configuration of the image formation apparatus 100 in FIG. 1. As shown in FIG. 2, the image formation apparatus 100 includes, for example, a sheet conveyance unit 201, an image formation unit 202, a communication unit 203, a control unit 204, a storage unit 205, an operation and display unit 206, and an inspection unit 207. The sheet conveyance unit 201 is a mechanism for conveying the paper 111 inside the image formation apparatus 100. For example, the sheet conveyance unit 201 is formed of a plurality of rollers. Using the plurality of rollers, the sheet conveyance unit 201 conveys the paper 111 conveyed from the paper feed unit 104 to the image formation unit 202. The sheet conveyance unit 201 conveys the paper 111 having passed the image formation unit 202 to the wind-up unit 105 using the plurality of conveyance rollers. The image formation unit 202 is formed by the first printhead 103 and the second printhead 102. Based on a print job, the image formation unit 202 forms an image on the paper 111 supplied from the paper feed unit 104. The communication unit 203 communicates with the image formation apparatus 100 and an external apparatus (e.g., a personal computer). The communication unit 203 includes, for example, a wired communication function formed of a communication control card such as a local area network (LAN) card. The external apparatus is connected to, for example, a communication network such as a LAN or a wide area network (WAN). Thus, the communication unit 203 enables transmission and reception of various kinds of data between the image formation apparatus 100 and an external apparatus via the communication network. The control unit 204 is formed by, for example, a central processing unit (CPU), random-access memory (RAM), and the like. The CPU of the control unit 204 reads various programs stored in the storage unit 205, such as system programs or processing programs, loads them into the RAM, and executes various kinds of processing according to the programs loaded. For example, as instructed by a user, the control unit 204 can perform image formation processing for executing a print job (hereinafter also referred to as a job). The storage unit 205 is formed by, for example, non-volatile semiconductor memory (e.g., flash memory), a hard disk drive (HDD), or the like. The storage unit 205 may be formed by a solid-state drive (SSD). Stored in the storage unit 205 are the various programs executed by the control unit 204, such as the system program and the processing program, as well as various kinds of data needed to execute the various programs.

The operation and display unit 206 is formed of, for example, a touch-panel liquid crystal display (LCD). The operation and display unit 206 includes a display unit 206a and an operation unit 206b. The display unit 206a displays various kinds of information on a screen displayed on the liquid crystal display according to a display control signal inputted from the control unit 204. The operation unit 206b receives operation on various operation keys such as numeric keys and a Start key. For example, the various operation keys are displayed on the liquid crystal display, and the touch panel recognizes operation performed on any of the operation keys by a user. Various operations by the user are thus received. Upon receipt of a user operation, the operation unit 206b generates an operation signal. The operation unit 206b outputs the operation signal thus generated to the control unit 204.

Next, a description is given of processing performed by the image formation apparatus 100 to form an image on the paper 111. First, in response to a user operating the external apparatus, the external apparatus creates foundation data and overprinting data for a job and configures print settings for the job. The external apparatus transmits the job to the image formation apparatus 100 via the communication network, the job including the foundation data, the overprinting data, and the print settings. The control unit 204 of the image formation apparatus 100 receives, via the communication unit 203, the data and print settings included in the job transmitted from the external apparatus. The control unit 204 checks whether the image can be printed without density unevenness. The control unit 204 causes the image formation unit 202 to print pattern data received via the communication unit 203 and causes the scanner unit 107 to scan the printed pattern data to detect density unevenness. The control unit 204 calculates a correction table based on the density unevenness detected. Although the control unit 204 can also check other items such as ejection failure and color range shift, the present embodiment focuses on inspection of density unevenness.

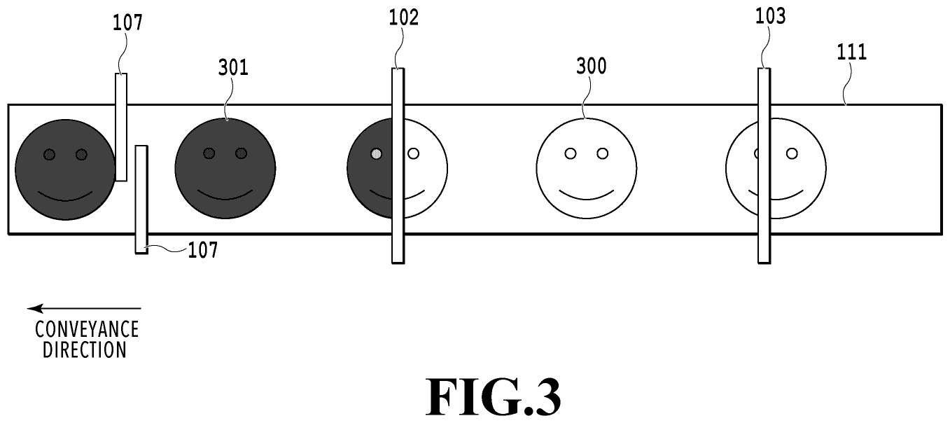

FIG. 3 is a conceptual diagram of a use case of regular printing. The image formation apparatus 100 keeps conveying the paper 111 in the conveyance direction. The image formation apparatus 100 prints an image 300 on the paper 111 being conveyed by ejecting ink from the first printhead 103. The image formation apparatus 100 fixates the printed image 300 onto the paper 111 using the dryer unit 112 and the cooler unit 113. After fixating the image 300 onto the paper 111, the image formation apparatus 100 performs overprinting of an image 301 by ejecting ink from the second printhead 102. The image formation apparatus 100 fixates the printed image 301 onto the paper 111 using the drier unit 106, the cooler unit 108, and the cooler unit 109. The second print unit 115 scans, using the scanner unit 107, the image 301 fixated on the paper 111. In the present embodiment, as shown in FIG. 3, there are two scanner units 107 installed. The scanner units 107 are arranged in a staggered manner.

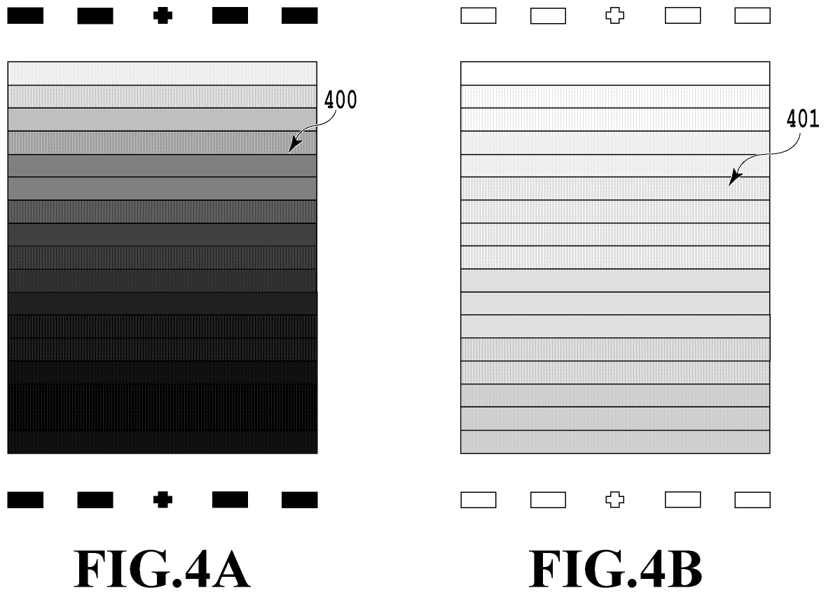

FIGS. 4A to 6D are diagrams showing examples of various patterns used in calculation of a density unevenness correction table. Descriptions are given sequentially below.

FIGS. 4A and 4B are diagrams showing example single-color detection patterns 400 and 401. The single-color detection patterns 400, 401 are used for calculation of a density unevenness correction table. The single-color detection patterns 400, 401 are printed to detect density unevenness. Specifically, the respective colors are printed consecutively in the event where the image formation apparatus 100 starts printing. FIG. 4A is a diagram showing an example of a single-color detection pattern 400, and FIG. 4B is a diagram showing an example of a white-ink detection pattern 401. In each of FIGS. 4A and 4B, the detection pattern is formed by a gradation region with different densities and detection mark regions. The detection pattern is printed in each of the ink colors in the image formation apparatus 100.

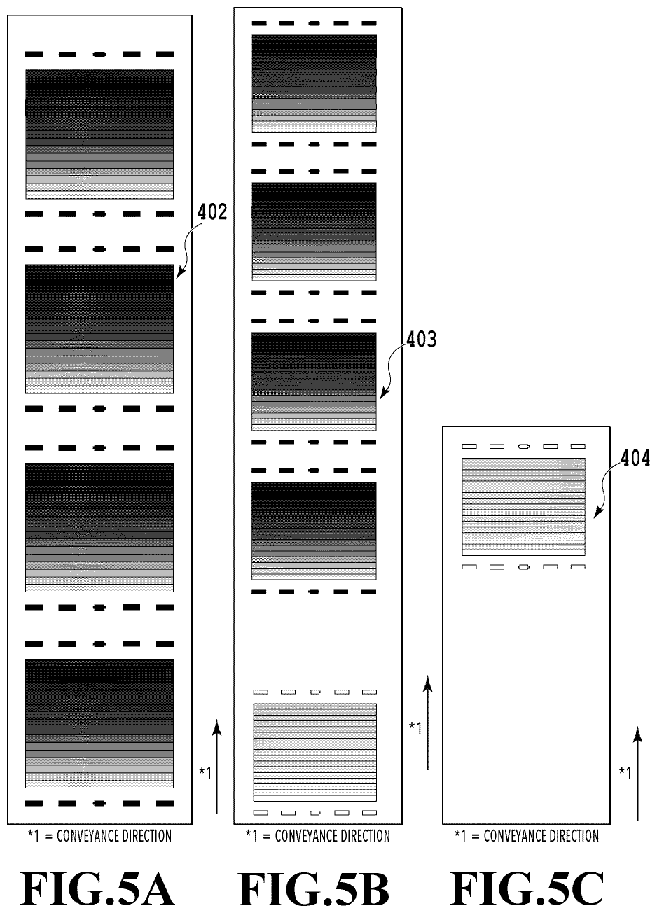

FIGS. 5A, 5B, and 5C are diagrams showing each of examples of full-color detection patterns 402, 403, and 404. The full-color detection patterns 402, 403, and 404 in FIGS. 5A, 5B, and 5C are the same as the single-color detection patterns 400, 401 in FIGS. 4A and 5A. FIG. 5A is a diagram showing the detection pattern 402 with four color inks. FIG. 5B is a diagram showing the detection pattern 403 with four color inks and a white ink. FIG. 5C is a diagram showing the detection pattern 404 with a white ink.

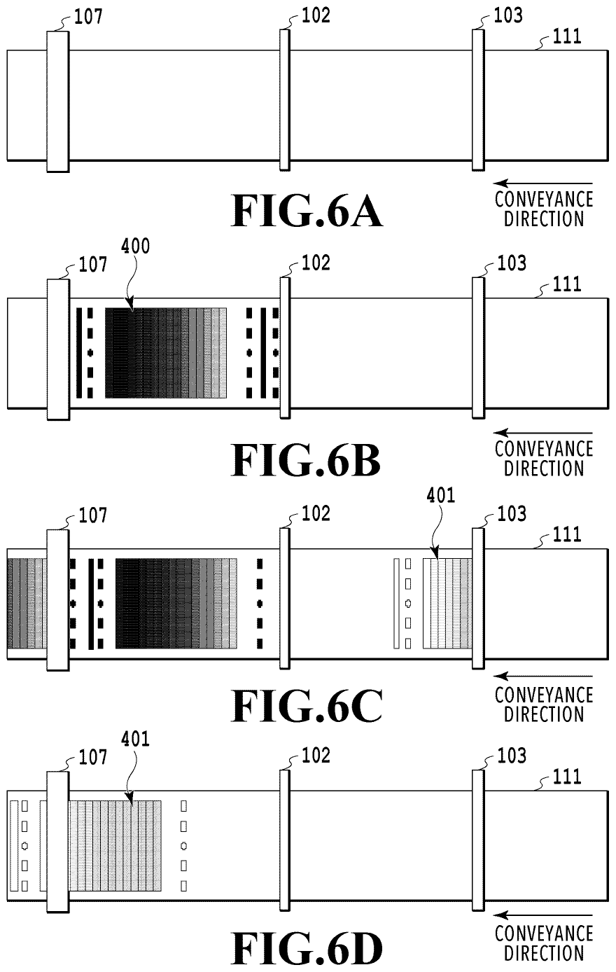

FIGS. 6A, 6B, 6C, and 6D are conceptual diagrams illustrating how the single-color detection patterns 400, 401 in FIGS. 4A and 4B are printed and scanned. FIG. 6A is a diagram showing an example of the paper 111 being conveyed in a conveyance direction before the detection pattern 400 is printed on the paper 111. FIG. 6B is a diagram showing an example of the single-color detection pattern 400 after being printed on the paper 111 and before being scanned by a scanner unit 107. FIG. 6C is a diagram showing an example of a state where the single-color detection pattern 400 is being scanned by the scanner unit 107 and the white-ink detection pattern 401 is being printed on the paper 111. FIG. 6D is a diagram showing an example of a state where the white-ink detection pattern 401 is being scanned by the scanner unit 107.

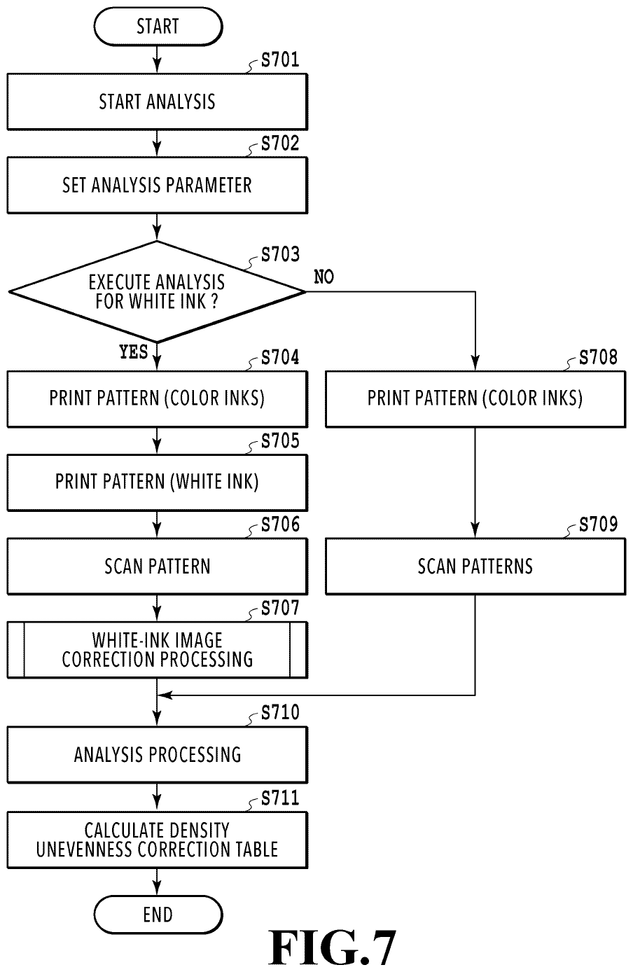

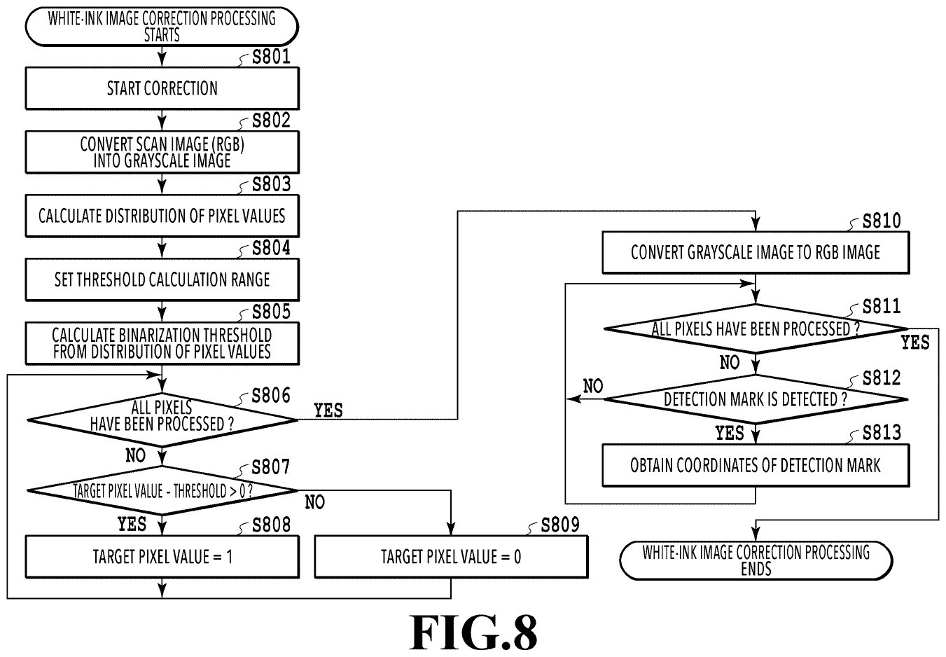

FIG. 7 is a flowchart illustrating the processing in FIGS. 6A, 6B, 6C, and 6D. FIG. 8 is a flowchart illustrating details of the process in S707 in FIG. 7. The present embodiment describes an example where the control unit 204 of the image formation apparatus 100 executes each process in the flowcharts in FIGS. 7 and 8, but the present disclosure is not particularly limited to this. It may be the CPU of the terminal device 119 that executes the processes in the flowcharts in FIGS. 7 and 8. Also, some of the processes in the flowcharts in FIGS. 7 and 8 may be executed by the image formation apparatus 100, and the rest of the processes may be performed by the terminal device 119. The processing shown in FIG. 7 may be executed at the time that, for example, density unevenness correction processing is selected on the UI operation panel 101. In other words, the processes shown in FIG. 7 are implemented by the CPU of the control unit 204. Note that some or all of the functions of the steps in FIGS. 7 and 8 may be implemented by hardware such as an application-specific integrated circuit (ASIC) or an electric circuit. The letter “S” used in the description of each process means that it is a step in the flowchart. Also, an apparatus or apparatuses that execute the processes in the steps in FIGS. 7 and 8 may be collectively referred to as an image processing apparatus.

In S701, based on a user instruction, the control unit 204 starts density unevenness correction processing with the image formation apparatus 100 in the state in FIG. 6A. In S702, as one of analysis parameters, the control unit 204 sets color information on an analysis target. For example, in a case where the analysis target is a white ink, the control unit 204 sets a color value corresponding to white as color information on the analysis target. Specifically, in a case where the analysis target is a CMYK pattern, the analysis parameter as the color information on the analysis target may be a parameter representing four colors. Alternatively, in a case where the analysis target is a white pattern, the analysis parameter as the color information on the analysis target may be a parameter representing one color (white foundation). Alternatively, in a case where the analysis target is CMYK patterns and a white pattern, the analysis parameter as the color information on the analysis target may be a parameter representing four colors+one color (white foundation).

In S703, the control unit 204 determines whether to execute density unevenness correction processing for a white ink. If it is determined to execute density unevenness correction processing for a white ink in S703, the processing proceeds from S703 to S704. In S704, the control unit 204 causes the second printhead 102 of the second print unit 115 to print the detection pattern 400 for color ink density unevenness analysis on the paper 111. Specifically, the second printhead 102 forms the detection pattern 400 in each of the ink colors (FIG. 6B). In other words, the detection patterns 400 for the respective ink colors are formed on the paper 111. In S705, after the detection patterns 400 for the color inks are printed (FIG. 6C), the control unit 204 causes the first print unit 116 to start printing the white-ink detection pattern 401 (FIG. 6C). As a result of the process in S704 and S705, the detection pattern 403 printed in four color inks and a white ink is formed (FIG. 5B). In S706, the control unit 204 causes the scanner unit 107 to scan the detection pattern 401. In S707, the control unit 204 performs correction processing necessary for detection. The process in S707 will be described in detail later using FIG. 8.

In S703, if it is determined not to execute density unevenness correction processing for a white ink, the processing proceeds from S703 to S708. In S708, the control unit 204 causes the second printhead 102 of the second print unit 115 to print the detection patterns 400 for color-ink density unevenness analysis on the paper 111. Specifically, the second printhead 102 forms the detection pattern 400 for each of the ink colors (FIG. 6B). In other words, the detection patterns 400 for the respective ink colors are formed on the paper 111. In S709, the control unit 204 causes the scanner unit 107 to scan the detection patterns 400.

In S710, the control unit 204 obtains scan data by the scanning and calculates a density unevenness correction table. It is assumed that coordinates, color values, and the like to use for the analysis are registered in advance in the apparatus. For example, the coordinates, color values, and the like to use may be set at the time of setting the analysis parameters in S702. In S711, the control unit 204 transmits analysis results to the image formation unit 202. The image formation unit 202 updates the density unevenness correction table based on the analysis results. After that, the processing ends.

### (White Ink Image Correction Processing)

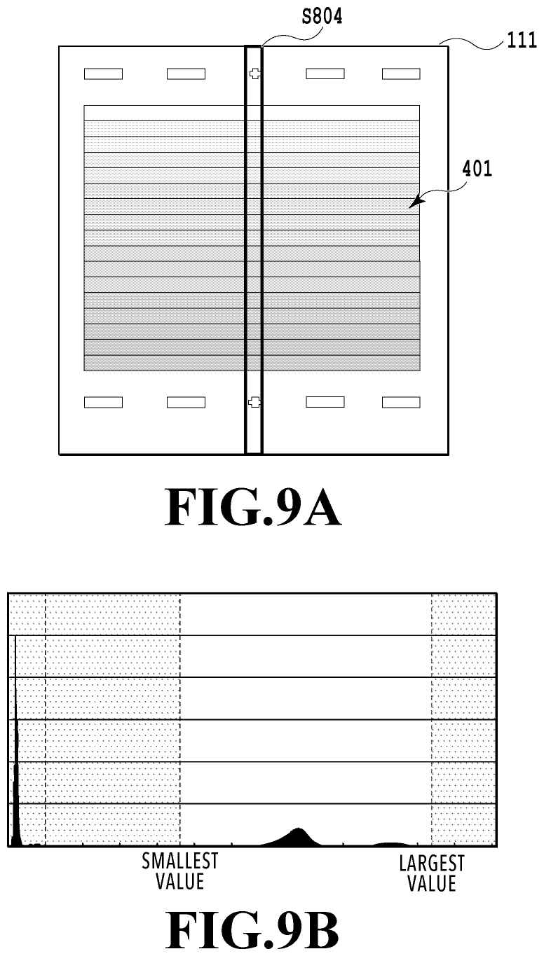

Next, the process in S707 in FIG. 7 is described using FIG. 8. In S801, the control unit 204 starts correction processing. Data used for the correction processing is described as needed with reference to FIGS. 9A and 9B. FIGS. 9A and 9B are diagrams showing example scan results obtained by the scanner unit 107. In S802, the control unit 204 converts the detection pattern scanned by the scanner unit 107 into a grayscale image. In S803, the control unit 204 calculates the distribution of pixel values in the grayscale image obtained by the conversion in S802. In S804, the control unit 204 sets the range usable in a process in S805 within the distribution of pixel values. FIG. 9A is a diagram showing an example of being set as a specified region on the image surrounded by the black thick line on the range of the distribution of pixel values of the image by the process in S804 in FIG. 8. FIG. 9B is a diagram showing an example of a histogram of the image representing the distribution of pixel values in the specified region on the image surrounded by the black thick line in FIG. 9A. In S804, the control unit 204 specifies a specified region including pixel values of the paper 111 and pixel values of the correction-target detection pattern 401 including detection marks. In S804, the control unit 204 sets a threshold calculation range by calculating the largest pixel value and the smallest pixel value in the specified region. In the example in FIG. 9A, a range of 30 pixels from the center part of the image is specified, taking the size of the detection pattern 401 into consideration. In the example in FIG. 9B, the largest pixel value and the smallest pixel value among the pixel values in the specified region are specified. In other words, focusing on the pixel values in between the largest and smallest pixel values not only allows removal of unwanted noise component, but also allows the dynamic range of the histogram representing the distribution of pixel values to be changed to the range between the largest and smallest pixel values. This operation may enable improvement in image contrast as well. Also, specifying the range of, for example, 30 px from the center part of the image to focus on the pixel values between the largest pixel value and smallest pixel value enables reduction in the amount of computation and in turn reduction in the computation time. Note that 30 px is an example, and the present disclosure is not particularly limited to this, as long as the threshold calculation range is specified in such a manner as to include at least one of the detection marks which is located at the center part of the image. Although cross-shaped marks are used in the present embodiment as marks located at the center part of the image, the present disclosure is not particularly limited to this shape.

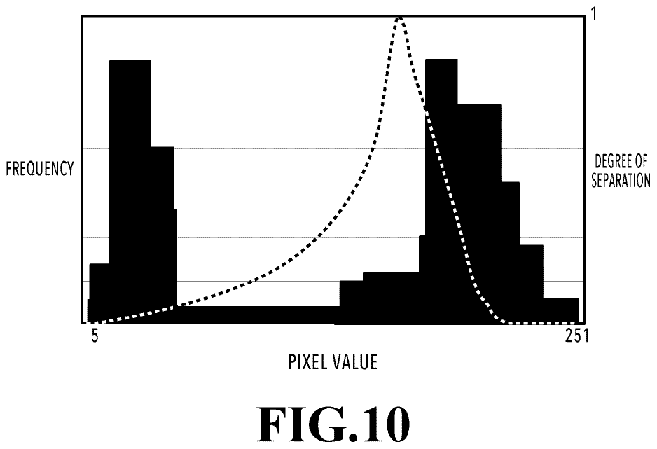

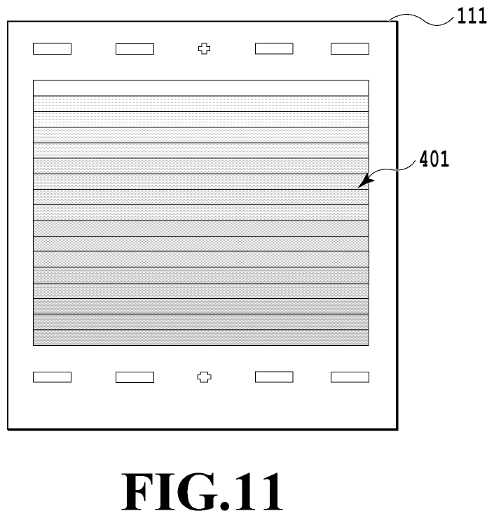

FIG. 10 is a diagram showing an example of being calculated as a degree of separation of two groups based on the distribution of pixel values. According to this degree of separation, pixel values except for the pixel values corresponding to the paper 111 and the pixel values of the correction-target detection pattern 401 can be removed as noise. The process in S805 is executed based on the specified region specified in the process in S804. In S805, the control unit 204 calculates a binarization threshold based on the distribution of pixel values. Because there are two groups of pixel values, namely the pixel values of the paper 111 and the pixel values of the correction-target detection pattern 401, the threshold is calculated using discriminant analysis, which sets the largest value of the degree of separation between two groups as a threshold. Other binarization methods include the mode method, the P-tile method, and a method using the correlation, but any method can be used as long as pixel values corresponding to the paper 111 and pixel values of the detection pattern 401 can be clearly distinguished. Thus, k-means clustering in unsupervised learning may be used. The degree of separation is calculated based on within-group variance and between-group variance of the two groups. Specifically, the pixel value where the degree of separation between the two groups is largest is set as the threshold. Also, the degree of separation is obtained by dividing between-class variance by within-class variance. Note that the pixel values of the detection pattern 402 printed in chromatic color inks are smaller than the pixel values of the foundation color corresponding to the paper 111. Meanwhile, the pixel values of the detection pattern 404 printed with a white ink are larger than the pixel values of the foundation color corresponding to the paper 111. FIG. 11 is a diagram showing an example of the detection pattern 401 used in the process in S806 in FIG. 8. In S806, the control unit 204 performs correction processing on all of the pixel values in FIG. 11.

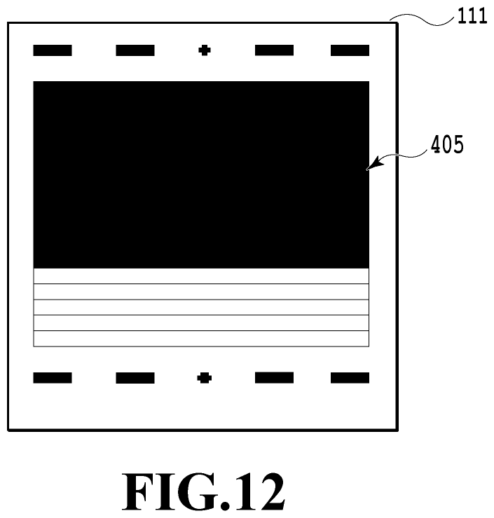

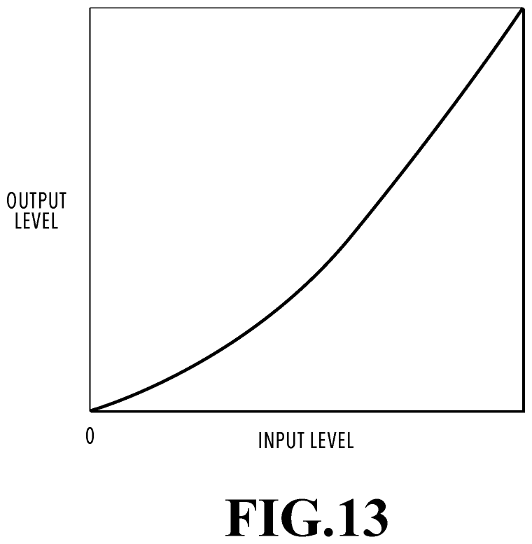

In S807, the control unit 204 obtains a difference between the target pixel value and the threshold found by the process in S805. If the difference is greater than 0, in S808, the control unit 204 sets the target pixel value to 1. If the difference is 0 or smaller than 0, in S809, the control unit 204 sets the target pixel value to 0. As a result of this operation, the pixel values of the white ink are inverted to black, and the pixel values corresponding to the paper 111 are inverted to white. In other words, given that the ink is a white ink, a pixel value in a portion to which ink was ejected is inverted to black, and a pixel value in a portion to which ink was not ejected is inverted to white. Also, if the process in S807 is completed for all the pixel values, in S810, the control unit 204 converts the grayscale image used in the processes in S803 to S809 into an RGB image. In S811 and S812, the control unit 204 performs edge detection on all the pixels of the image generated by the process in S810. As a result of this operation, white-ink detection marks are obtained. For the obtainment of the detection marks, for example, edge detection using a differential filter is employed. Thus, locations with a large difference in pixel value is extracted. FIG. 12 is a diagram showing an example detection pattern 405 obtained by the process in S807 in FIG. 8. In the process in S812 and S813, for example, the control unit 204 obtains the coordinates of white-ink detection marks by using FIG. 12. In other words, in S813, the control unit 204 obtains the coordinates of the detection marks. After the edge detection is executed on all the pixels, the process in S811 ends and proceeds to process in S711. In S711, the control unit 204 calculates density unevenness correction table characteristics by using the positions of the detection marks obtained by the process in S813 as analysis-reference coordinates. FIG. 13 is a diagram showing a correction table representing density characteristic of the ink. FIG. 13 shows an example where an output level is determined according to an input level. A relation between an input level and an output level is identified by the correction table in FIG. 13. The larger the input level, the larger the output level, compared to a linear change. Conversely, the smaller the input level, the smaller the output level, compared to a linear change. It is assumed as an example that an input level corresponds to the input density of the ink and an output level corresponds to the output density of the ink. Under this assumption, referring to FIG. 13, between an input density in a high density domain and an input density in a low density domain lower in density than the high density domain, different values are set as a correction amount for the corresponding output density. Specifically, in the correction table in FIG. 13, a bright, high-density contrast becomes larger, and a dark, low-density contrast becomes smaller. The number of times the ink is ejected is controlled based on the output level. In other words, the correction table in FIG. 13 associates the amount of correction to reduce the density unevenness of ink and the number of times the ink is to be ejected. Specifically, by formatting input levels and output levels as a lookup table, the correction table in FIG. 13 enables conversion from pre-conversion pixel values to post-conversion pixel values without computation.

As described above, according to the present embodiment, the CPU of the control unit 204 obtains image data by scanning an image formed on a printing medium using printing elements that eject ink. Based on a histogram representing the distribution of pixel values in a specified region on the image, the CPU of the control unit 204 classifies the pixel values into a mark distribution and a foundation distribution. The mark distribution includes, among the pixel values of the image, pixel values in a portion corresponding to a detection mark printed with ink. The foundation distribution includes, among the pixel values of the image, pixel values in a portion where ink was not ejected. Based on the mark distribution, the CPU of the control unit 204 generates characteristic data representing the density characteristic of the ink ejected from the printing elements. With such a configuration, even in a case where a density test pattern is in a color with small contrast to the printing medium, the histogram of the image maps the number of times each pixel value appears on the image and therefore can classify pixel values into a mark distribution and a foundation distribution. Thus, characteristic data indicating the density characteristic of ink can be generated based on the mark distribution separated from the foundation distribution. Hence, density correction can be done based on this characteristic data. Thus, a density test pattern can be detected even under difficult conditions for scanning the density test pattern so that density unevenness can be corrected.

Also, according to the present embodiment, a specified region on the image may include pixel values in a portion where ink was not ejected and pixel values in a portion with the highest density among the pixel values in the portion where ink was ejected. With such a configuration, a specified region on the image includes pixel values in a portion where ink was not ejected and pixel values in a portion with the highest density among the pixel values in the portion where ink was ejected. The portion where ink was not ejected corresponds to a foundation portion. The portion with the highest density among the pixel values in the portion where ink was ejected corresponds to a detection mark. Thus, narrowing the image down to the specified region not only widens the dynamic range of the histogram, but also narrows pixel values down to ones including a detection mark. Also, pixel values required for computation can be cut down, which enables shorter computation time and lower computation cost.

Also, according to the present embodiment, a threshold may be set based on pixel values between the pixel values in the portion where ink was not ejected and the pixel values in the portion with the highest density among the pixel values in the portion where ink was ejected. Also, based on the threshold, binarization processing is performed on the image data to extract the coordinates of the detection mark included in the mark distribution. With such processing, even in a case where the density test pattern has small color contrast, such binarization processing executed based on the threshold enables the density test pattern to be distinguished from the foundation color.

Also, according to the present embodiment, characteristic data may be generated based on the coordinates of the detection mark. With such processing, displacement of the center of the image can be corrected based on the coordinates of the detection mark. Displacement of the center of the image is affected by variance in quality that occurs in the manufacturing process, deterioration over time, and the like. Thus, characteristic data can be data considering influences such as variance in quality caused in the manufacturing process or deterioration over time.

Also, according to the present embodiment, the number of times ink is ejected may be controlled based on the characteristic data. With such processing, the number of times ink is ejected is controlled considering influences such as variance in quality caused in the manufacturing process or deterioration over time, and thus, ink ejection control can be done considering factors causing density unevenness on the image.

Also, according to the present embodiment, the characteristic data may be formed of a correction table associating correction amounts for reducing density unevenness of ink ejected from the printing elements with numbers of times the ink is to be ejected. With such a configuration, even if the density pattern has small color contrast, the number of times ink is ejected can be controlled to improve density unevenness of the ink.

Also, according to the present embodiment, the correction table is formed of input densities and output densities corresponding to the input densities, and between an input density in a high density domain and an input density in a low density domain lower in density than the high density domain, different values may be set as a correction amount for the corresponding output density. With such a configuration, a different correction amount can be set for each density region. Thus, in a case where correction can be done on a density domain basis, computation cost can be reduced drastically, and processing speed can be improved.

Also, according to the present embodiment, a difference between the contrast of a portion where ink was ejected on a printing medium and the contrast of a portion where ink was not ejected on the printing medium may be smaller than preset contrast. With such a configuration, correction can be done even under difficult conditions for scanning a density test pattern due to small contrast.

Also, according to the present embodiment, the color of ink may be achromatic color. With such a configuration, correction can be done even in a situation where there is no contrast between the foundation color and the ink color.

Also, according to the present embodiment, the ink is at least one of a white ink and a clear ink, and the printing element may further eject, in addition to the ink, a reaction liquid for increasing the viscosity of the ink. With such a configuration, correction can be done even in a situation where there is no contrast between the foundation color and the ink color.

Also, according to the present embodiment, an image may include a gradation region where a plurality of patterns with different densities are disposed in stages and a detection mark region where a detection mark is disposed. With such a configuration, gradation correction and density correction can be performed simultaneously.

Also, according to the present embodiment, whether to correct the contrast of the image may be determined according to a difference between the contrast of the portion where ink was ejected on the printing medium and the contrast of the portion where ink was not ejected on the printing medium. With such processing, correction processing can be analyzed in a case where the difference between the above contrasts is smaller than a predetermined difference. For example, whether to execute the process in and after S704 is determined in the process in S703 in FIG. 7 based on the analysis parameters obtained in the process in S702. In place of the process in S703, whether to execute the processes in and after S704 can be determined based on the difference between the above contrasts.

Also, according to the embodiment, the distribution of pixel values in a specified region on the image may be computed based on a grayscale image converted from image data, and the threshold for classification into the mark distribution and the foundation distribution may be computed based on the distribution of pixel values in the specified region on the image. With such processing where classification into the mark distribution and the foundation distribution is performed after conversion of the image data into the grayscale image, the classification into the above distributions can be done using black and white separation.

Also, according to the present embodiment, a first class including the mark distribution may be set, and a second class including the foundation distribution may be set. Also, based on the variance of the first class and the variance of the second class, within-class variance representing the dispersion magnitude of the first class and the second class may be set, and between-class variance representing the degree of dispersion between the first class and the second class may be set. Also, the pixel value where the degree of separation found based on the ratio between the within-class variance and the between-class variance is largest may be set as the threshold. With such a configuration, classification into the mark distribution and the foundation distribution can be done automatically using discriminant analysis.

Also, according to the present embodiment, binarization processing on image data may be performed based on the threshold found by discriminant analysis. With such processing, binarization processing can be performed on the image data classified by discriminant analysis.

Also, according to the present embodiment, binarization processing may be performed based on the difference between the threshold and each pixel value included in the image data. With such a configuration, pixel values included in image data can be binarized depending on whether they are greater than the threshold. Thus, the distribution of pixel values can be divided into two groups using the threshold.

Also, according to the present embodiment, a degree of separation may be found within the range from the smallest pixel value to the largest pixel value specified within the specified region. With such processing, the degree of separation can be found after the dynamic range is enlarged.

Various examples and embodiments of the present disclosure have been described above, but the gist and scope of the present disclosure are not limited specifically to what is described herein. The present disclosure is not limited to the embodiments described above and may be variously modified. Also, in the present disclosure, the embodiments may be partially combined as needed.

### (Modification 1)

For example, the image formation apparatus 100 includes the paper feed unit 104, the first print unit 116, the second print unit 115, and the wind-up unit 105 in the example described above, but the present disclosure is not particularly limited to this. For example, the scanner unit 107 included in the second print unit 115 may be disposed between a stage after the second print unit 115 and the wind-up unit 105. Also, a color measurement unit capable of detecting color more accurately than the scanner unit 107 may be disposed. As to the placement of the color measurement unit, the color measurement unit may be disposed between a stage after the second print unit 115 and the wind-up unit 105 or may be disposed inside of the second print unit 115 and downstream of the drier unit 106.

### (Modification 2)

Also, for example, the scanner unit 107 obtains color information on the paper 111 in the above embodiments, but the present disclosure is not particularly limited to this. Other sensor may be used for scanning. For example, a colorimeter (not shown) may be disposed on a conveyance path for the paper 111 and used to obtain color information on the paper 111.

### (Modification 3)

Also, for example, continuous paper 111 is used as a printing medium in the example described above, but the present disclosure is not particularly limited to this. For example, cut paper or rolled paper may be used instead of the continuous paper 111. Also, the printing medium may be made of a film or other material. Also, there are no particular limitations on the material of the printing medium. Also, the continuous paper 111 as the printing medium is colored paper in the example described above, but the present disclosure is not particularly limited to this. The printing medium may be a clear material or a metallic material. Also, there are no particular limitations on the color of the surface and the characteristics of the printing medium.

### (Modification 4)

Also, the images 300 and 301 in FIG. 3 have the same design in the example described above, but the present disclosure is not particularly limited to this. The images 300 and 301 in FIG. 3 may have different designs.

### (Modification 5)

Also, the image formation apparatus 100 includes the first print unit 116 and the second print unit 115 in the example described above, but the present disclosure is not particularly limited to this. There may be either one of the first print unit 116 and the second print unit 115. Alternatively, a unit integrating the first print unit 116 and the second print unit 115 may be used. Alternatively, a third printing unit (not shown) may be included in addition to the first print unit 116 and the second print unit 115. The third printing unit may be, for example, a unit provided with a colorimeter. Alternatively, the third printing unit may be a unit including a function to attach stickers. Alternatively, the third printing unit may be a unit including a function to cut the paper 111. Alternatively, the third printing unit may be a unit including a function to print labels.

### (Modification 6)

Also, the present embodiment described an example of calculating a correction table for a white ink, but the present disclosure is not particularly limited to this. For example, a correction table may be calculated for an achromatic ink which makes pattern detection difficult, such as a reaction liquid or a clear ink.

### (Modification 7)

Also, discriminant analysis, which sets the largest value of the degree of separation between two groups as a threshold, is used for the binarization threshold in the example described above, but the present disclosure is not particularly limited to this. For instance, the mode method, the P-tile method, and a method using the correlation may be used. Any method can be used as long as it enables clear distinguishment between pixel values of the paper 111 and pixel values of the detection pattern 401. For example, k-means clustering in unsupervised learning may be used.

### (Modification 8)

Also, for example, the communication unit 203 includes a function to perform wired communications via a LAN or the like in the example described above, but the present disclosure is not particularly limited to this. For example, the communication unit 203 may include a function for wireless communications conforming to standards such as 5G or 6G. Also, the communication unit 203 transmits and receives various kinds of data to and from an external apparatus connected to a communication network such as a LAN or a WAN in the example described above, but the present disclosure is not particularly limited to this. For example, the communication unit 203 may transmit and receive various kinds of data to and from a cloud providing various cloud services. With such a configuration, the image formation system can form images by organically connecting to the cloud and receiving a print job from, for example, a remote external apparatus. Also, the image formation system can share results of various processes with the remote external apparatus by uploading the results of various processes to the cloud.

### (Modification 9)

Also, RGB values of an analysis target are obtained as color information of the analysis target in the process in S702 in the example described in the present embodiment, but the present disclosure is not particularly limited to this. For example, YUV color space may be used. YUV color space is a color space used to transmit video signals. YUV color space differs from RGB color space in that luminance (Y) and color differences (U, Y) are separately represented. Luminance (Y) corresponds to a black and white image. Color differences (U, V) represent color information. Because there is a clear difference between white and black in YUV color space, YUV values can be used as color information on an analysis target. Alternatively, YIQ color space may be used. In YIQ color space, Y is luminance and I and Q are 33° rotated versions of U and V. Thus, there is a clear difference between black and white, and YIQ values can be used as color information on an analysis target according to the present embodiment. Alternatively, HSV color space may be used. HSV color space is formed by three components: hue, saturation (chroma), and value (brightness). Thus, there is a difference between white and black depending on the value (brightness), and for this reason HSV values can be used as color information on an analysis target according to the present embodiment. However, additional determination processing is needed. For example, in a case where value (brightness)=100 and saturation=0, the pixel value is determined to be white irrespective of the value of hue. Also, in a case where the value=0, the pixel value is determined to be black irrespective of the values of saturation and hue. Alternatively, Lab color space may be used. L represents lightness, and there is clear difference between white and black. Thus, Lab values can be used as color information on an analysis target according to the present embodiment. In other words, an analysis target according to the present embodiment is either a CMYK pattern or a white pattern. Also, although RGB color space is used in the present embodiment as color information on an analysis target according to the present embodiment, there are no particular limitations on the color space as long as the value of white and the value of black are away from each other.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, density unevenness can be corrected even under difficult conditions for scanning a density test pattern.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-210525, filed Dec. 3, 2024 which is hereby incorporated by reference herein in its entirety.

What is claimed is:

1. An image processing apparatus comprising:
an obtainment unit configured to obtain image data acquired by scanning of an image formed on a printing medium using a printing element configured to eject an ink;
a classification unit configured to classify, based on a histogram representing a distribution of pixel values in a specified region on the image, pixel values of the image into a mark distribution and into a foundation distribution, the mark distribution including pixel values of a portion of corresponding to a detection mark of the image being printed with the ink, the foundation distribution including pixel values of a portion of the image being not printed with the ink by no ejection; and
a generation unit configured to generate characteristic data based on the mark distribution, the characteristic data representing a density characteristic of the ink ejected from the printing element.

2. The image processing apparatus according to claim 1, wherein
a specified region on the image includes pixel values of the portion of the image being not printed with the ink by no ejection and pixel values of a portion of the image with highest density among pixel values of a portion of the image being printed with the ink by ejection.

3. The image processing apparatus according to claim 2, wherein
the classification unit sets a threshold based on pixel values between the pixel values of the portion of the image being not printed with the ink by no ejection and the pixel values of a portion of the image with highest density among pixel values of a portion of the image being printed with the ink by ejection, and
the generation unit extracts coordinates of the detection mark included in the mark distribution by performing binarization processing on the image data based on the threshold.

4. The image processing apparatus according to claim 3, wherein
the generation unit generates the characteristic data based on the coordinates of the detection mark.

5. The image processing apparatus according to claim 4, further comprising a control unit configured to control a number of times of the ink ejected, based on the characteristic data.

6. The image processing apparatus according to claim 5, wherein
the characteristic data is formed of a correction table associating a correction amount to reduce density unevenness of the ink ejected from the printing element with the number of times of the ink ejected.

7. The image processing apparatus according to claim 6, wherein
the correction table is formed of an input density and an output density corresponding to the input density, and
each of a correction amount for the output density corresponding to the input density in a high density domain and a correction amount for the output density corresponding to the input density in a low density domain lower than the high density domain is set as a different value.

8. The image processing apparatus according to claim 1, wherein
a difference between contrast of a portion of the image being printed on the printing medium with the ink by ejection and contrast of a portion of the image being not printed on the printing medium with the ink by no ejection is smaller than preset contrast.

9. The image processing apparatus according to claim 1, wherein
a color of the ink is an achromatic color.

10. The image processing apparatus according to claim 1, wherein
the ink is at least one of a white ink and a clear ink, and
the printing element further ejects a reaction liquid in addition to the ink to increase viscosity of the ink.

11. The image processing apparatus according to claim 1, wherein
the image includes a gradation region where a plurality of patterns different in density are disposed in stages and a detection mark region where the detection mark is disposed.

12. The image processing apparatus according to claim 1, further comprising a determination unit configured to determine whether to correct contrast of the image in accordance with a difference between contrast of a portion of the image being printed on the printing medium with the ink by ejection and contrast of a portion of the image being not printed on the printing medium with the ink by no ejection.

13. The image processing apparatus according to claim 3, further comprising:
a conversion unit configured to convert the image data to a grayscale image;
a distribution computation unit configured to compute a distribution of pixel values in a specified region on the image from the grayscale image; and
a threshold computation unit configured to compute, based on the distribution of pixel values in the specified region on the image, the threshold used for classifying into the mark distribution and the foundation distribution.

14. The image processing apparatus according to claim 13, wherein
a first class including the mark distribution is set,
a second class including the foundation distribution is set,
based on variance of the first class and variance of the second class, within-class variance representing a magnitude of variability of the first class and the second class is set,
between-class variance representing a degree of variability between the first class and the second class is set, and
the generation unit sets, as the threshold, a pixel value where a degree of separation found based on a ratio between the within-class variance and the between-class variance is largest.

15. The image processing apparatus according to claim 14, wherein
the generation unit performs the binarization processing on the image data based on the threshold.

16. The image processing apparatus according to claim 15, wherein
the generation unit finds the degree of separation within a range between a smallest pixel value and a largest pixel value identified in the specified region.

17. The image processing apparatus according to claim 16, wherein
the generation unit performs the binarization processing based on a difference between the threshold and pixel values included in the image data.

18. An image processing method comprising:
obtaining image data acquired by scanning of an image formed on a printing medium using a printing element configured to eject an ink;
based on a histogram representing a distribution of pixel values in a specified region on the image, classifying pixel values of the image into a mark distribution and into a foundation distribution, the mark distribution including pixel values of a portion of corresponding to a detection mark of the image being printed with the ink, the foundation distribution including pixel values of a portion of the image being not printed with the ink by no ejection; and
generating characteristic data based on the mark distribution, the characteristic data representing a density characteristic of the ink ejected from the printing element.

19. A computer-readable storage medium storing a program that causes a computer to execute:
obtaining image data acquired by scanning of an image formed on a printing medium using a printing element configured to eject an ink;
based on a histogram representing a distribution of pixel values in a specified region on the image, classifying pixel values of the image into a mark distribution and into a foundation distribution, the mark distribution including pixel values of a portion of corresponding to a detection mark of the image being printed with the ink, the foundation distribution including pixel values of a portion of the image being not printed with the ink by no ejection; and
generating characteristic data based on the mark distribution, the characteristic data representing a density characteristic of the ink ejected from the printing element.

20. An image formation system comprising:
an image processing apparatus and
a printhead having a printing element ejecting an ink, the printhead configured to form an image on a printing medium by ejecting the ink, wherein
the image processing apparatus includes
an obtainment unit configured to obtain image data acquired by scanning of an image formed on a printing medium using the printing element,
a classification unit configured to classify, based on a histogram representing a distribution of pixel values in a specified region on the image, pixel values of the image into a mark distribution and into a foundation distribution, the mark distribution including pixel values of a portion of corresponding to a detection mark of the image being printed with the ink, the foundation distribution including pixel values of a portion of the image being not printed with the ink by no ejection, and
a generation unit configured to generate characteristic data based on the mark distribution, the characteristic data representing a density characteristic of the ink ejected from the printing element.

21. The image formation system according to claim 20, further comprising:
an upstream scan unit configured to scan the image and obtain upstream image data;
a downstream scan unit disposed in a staggered manner relative to the upstream scan unit and configured to scan the image and obtain downstream image data; and
a synthesizing unit configured to obtain the image data by synthesizing the upstream image data and the downstream image data.
